(19) United States
(12) Patent Application Publication
(10) Pub. No.: US 2005/0136223 A1
(43) Pub. Date: Jun. 23, 2005

(54) Chamfering method, forging device used in the chamfering method, and chamfered product

(75) Inventor: Tetsuya Hoguchi, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: O-OKA CORPORATION, Nagoya-shi (JP)

(21) Appl. No.: 10/739,278

(22) Filed: Dec. 19, 2003

(51) Int. Cl. B32B 3/02

(52) U.S. Cl. 428/157; 264/138; 264/296; 425/406

(57) ABSTRACT

A chamfer processing method for forming a chamfer part in a producing method for molding a product which has a cut-finished surface by cutting and penetrated hole or concave portion opening to said cut-finished surface, wherein chamfer processing step for chamfer processing previously the chamfer part by press molding at a corner part between the cut-finished surface and the penetrated hole or concave portion, and cutting step for cut-finishing the cut-finished surface in order to remain the chamfer part on the corner part between the cut-finished surface and the penetrated hole or concave portion.

### BACKGROUND OF THE INVENTION

1. Field of the Invention

The present invention relates to a technology for restraining weld flash generated by cutting process to the minimum when products having a cut-finished surface by cutting and an adjacent surface intersected with the cut-finished surface are molded.

2. Description of the Related Art

As shown in FIG. 12, a weld flash 22 is generated at a corner part between a cut-finished surface and an adjacent intersecting surface, toward a moving direction of cutting tools, when the cut-finished surface is formed flatly by cutting a part of a molding article.

Therefore a generated weld flash is removed by using a wire brush, a file (rasp) or an electrolytic burring machine, and if necessary, a corner part is chamfered.

In the conventional practice, it was common that one product had many portions whereon weld flash were generated. It was difficult to remove the weld flash one by one. The finished surface was scratched and the condition of the finished surface after removing weld flash varied widely in a scattering due to the manual work. In result the available percentage was bad.

### SUMMARY OF THE INVENTION

It is a general object to provide a chamfering method and forging technique for decreasing weld flash generated by cutting, uniforming finishes of corner parts and uplifting a working property and a stability of quality.

It is an object to provide a chamfering method and forging technique in which weld flash is not generated because a product has a chamfer formed beforehand on a corner part of a finished surface and the adjacent surface.

It is a further object to provide a chamfering method and forging technique in which deburring is not required, and further, the sizes of the products having a chamfer formed by forging are exactly the same and have uniformity, and then a problem of dispersion may be solved.

It is a still further object to provide a chamfering method and forging technique in which working property may be enhanced and uniform quality may be assured.

It is a yet further object to provide a chamfer processing method for forming a chamfer part on a product which has a cut surface and an adjacent surface having the different angle with that of the cut surface, wherein comprises chamfer process step for chamfer processing previously at a corner part between the cut surface and the adjacent surface in order to form the chamfer part, and cutting step for cutting the cut surface in order to remain the chamfer part on the corner part between the cut surface and the adjacent surface.

It is another object to provide a chamfer processing method in which the cut surface is a cut-finished surface finished by cutting, and the adjacent surface is intersected with the cut-finished surface.

It is a further object to provide a chamfer processing method in which the chamfer part is press molded.

It is a still further object to provide a chamfer processing method for forming a chamfer part in a producing method for molding a product which has a cut-finished surface by cutting and an adjacent surface intersected with the cut-finished surface, wherein comprises chamfer processing step for chamfer processing previously the chamfer part by press molding at a corner part between the cut-finished surface and the adjacent surface in order to form the chamfer part, and cutting step for cut-finishing the cut-finished surface in order to remain the chamfer part on the corner part between the cut-finished surface and the adjacent surface.

It is a yet further object to provide a chamfer processing method for forming a chamfer part in a producing method for molding a product which has a cut-finished surface by cutting and penetrated hole or concave portion opening to the cut-finished surface, wherein comprises chamfer processing step for chamfer processing previously the chamfer part by press molding at a corner part between the cut-finished surface and the penetrated hole or concave portion, and cutting step for cut-finishing the cut-finished surface in order to remain the chamfer part on the corner part between the cut-finished surface and the penetrated hole or concave portion.

It is another object to provide a chamfer processing method in which the molded part and the chamfer part of the product are formed simultaneously by one press molding step.

It is a further object to provide a chamfer processing method for forming a chamfer part in a producing method for molding a product which has a cut-finished surface by cutting and penetrated hole opening to the cut-finished surface, in which the chamfer part having the draft angle is formed at a corner part between the cut-finished surface and the penetrated hole formed by punching of a punch, and the cut-finished surface is cut-finished in order to remain the chamfer having the draft angle at the corner part between the cut-finished surface and the penetrated hole.

It is a still further object to provide a chamfer processing method for forming a chamfer part in a producing method for molding a product which has a cut-finished surface by cutting and penetrated hole opening to the cut-finished surface, wherein the chamfer part having the draft angle is formed at a corner part between the cut-finished surface and the penetrated hole formed by punching of a punch from the opposite side of the cut-finished surface to the cut-finished surface, and the cut-finished surface is cut-finished in order to remain the chamfer having the draft angle at the corner part between the cut-finished surface and the penetrated hole.

It is a yet further object to provide forging device for forming a product having a cut surface and adjacent surface having the different angle with that of the cut surface, wherein comprises a chamfer processing portion for chamfer processing provided at a part corresponding to a corner part between the cut surface and the adjacent surface.

It is a yet further object to provide a product having a chamfer part between a cut surface and an adjacent surface having the different angle with that of the cut surface, in which the chamfer part is press molded at a corner part between the cut surface and the adjacent surface.

It is another object to provide a product having a chamfer part between a cut-finished surface and a penetrated hole or a concave portion opening to the cut surface, in which the chamfer part is press molded at a corner part between the cut surface and the adjacent surface.

It is a further object to provide a product having a chamfer part at a corner part between a cut-finished surface and a penetrated hole opening to the cut-finished surface, in which the chamfer part having the draft angle is formed at the corner part between the cut-finished surface and the penetrated hole by punching of a punch from the opposite side of the cut-finished surface to the cut-finished surface.

In the present invention, since the cut surface is cut in order to remain the chamfer part previously formed by the chamfer processing step on the corner part between the cut surface and the adjacent surface, the weld flash generated by cutting process is restrained to minimum and it is unnecessary that the generated weld flash is removed on the removing step.

In case of the chamfer part being formed by forging step, the formed chamfer part is accurately uniform to an inch in each product and the scattering of the formed chamfer part is reduced.

In result, according to the present invention it is possible to improve steps of the work and to maintain the uniform quality of the product.

### BRIEF DESCRIPTION OF THE DRAWINGS

FIGS. 1A, 1B, 1C and 1D are explanation views showing a method according to a first embodiment of the present invention;

FIG. 2 is an enlarged view showing an upper punch portion on a punch formed of a cope;

FIG. 3 is an explanation view showing a concave portion of a first molded article;

FIG. 4 is an explanation view showing a cut-finished surface;

FIGS. 5A and 5B are explanation views showing a molding process of a second embodiment of the present invention;

FIG. 6 is an explanation view showing a concave portions of a first molded article according to the second embodiment;

FIG. 7 is an explanation view showing a pierce process;

FIGS. 8A, 8B, 8C and 8D are explanation views showing a molding process according to a third embodiment of the present invention;

FIG. 9 is an explanation view showing a penetrating hole of a first molded article according to the third embodiment;

FIG. 10 is an explanation view showing the penetrating hole having a sloping surface formed into chamfer according to the third embodiment;

FIG. 11 is an explanation view showing a modification of a finished surface; and

FIG. 12 is an explanation view showing a conventional condition of a weld flash occurrence.

### DETAILED DESCRIPTION OF THE PREFERRED EMBODIMENTS

Referring to drawings, perforated clutch gear of the preferred embodiment according to a chamfering method of the present invention will be described.

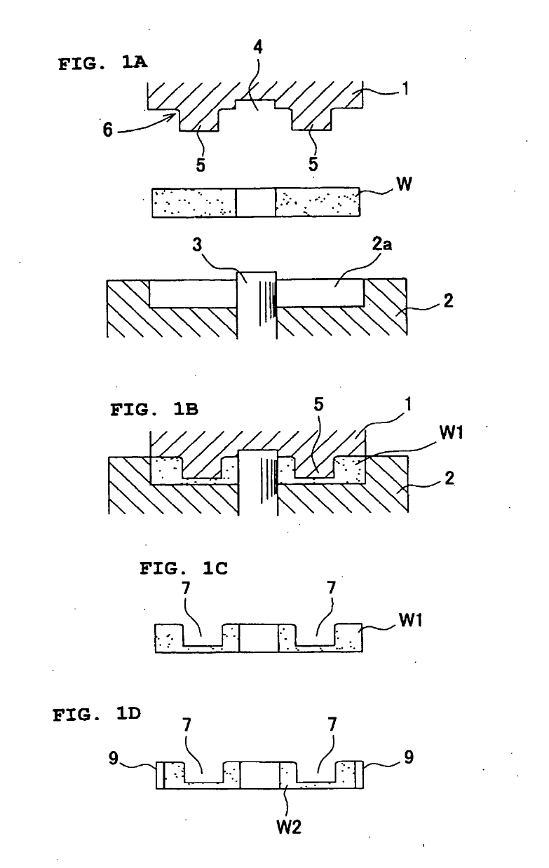

FIGS. 1A-1D are views showing molding process using the forging device. In FIGS. 1A-1D, 1 is a cope and 2 is a drag.

A disc form cavity 2a is formed on the drag 2 and a top surface of the cavity 2a is open. A mandrel 3 is provided in a center hole of the cavity 2a.

On the other hand, escape concave portion 4 is formed on the surface of the cope 1 by digging a part corresponding to the mandrel 3 and pusher punches 5,5 . . . are provided concentrically with the escape concave portion 4.

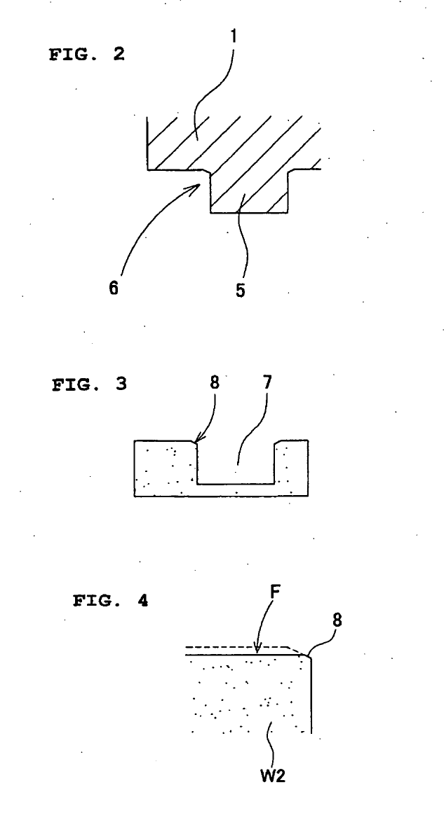

As shown in FIG. 2, surfaces 6 for forming chamfer parts are formed around on a base of the pusher punches 5,5 . . . , at a part corresponding to a corner part between a cutting surface and an adjacent intersecting surface.

When a doughnut-type work W is set in the cavity 2a of the drag 2 by this chamfer device and the work W is pressed by sending the cope 1 down, the work W is depressed in the cavity 2a and the pusher punches 5,5 . . . intrude into the work W deeply, as shown FIG. 1B.

After finishing molding, the cope 1 is sent up and knockout pins (not shown in figures) push the work W out so as to provide the first molded article WI having concave portions 7,7 . . . formed on the top surface thereof, as shown in FIG. 1C.

A chamfer part 8 is formed at the corner part of the finished surface and the concave portions 7 formed on the surface of this first molded article W1, as shown in FIG. 3.

Then a peripheral surface of the first molded article W1 is cut so as to form tooth 9 form on the peripheral surface of the first molded article W1 and a top surface of the first molded article W1 having the concave portions 7 is cut so as to form a finished surface F and provide product W2.

As shown in FIG. 4, it is necessary to cut the cut-finished surface so as to remain the chamfer part at the corner part of the finished surface F and the concave portion 7 in the finishing process. Therefore, it is possible to prevent or restrain occurring of weld flash on an elongation of a cutting direction.

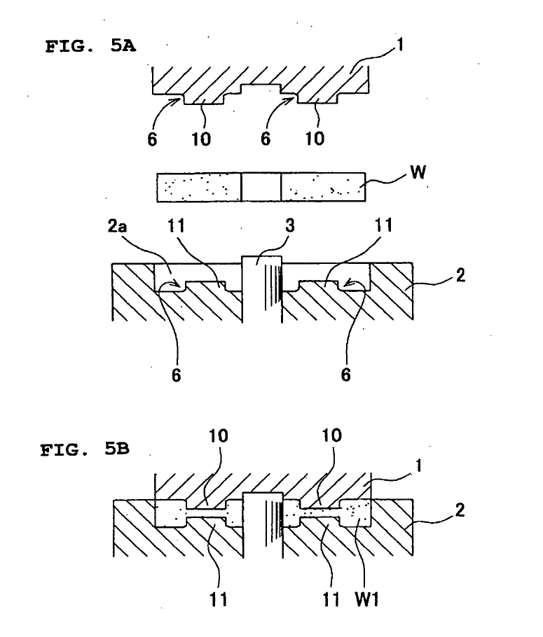

The first embodiment of the present invention was described on the product having the concave portions formed on one side surface thereof. The present invention is not to be restricted by the first embodiment and may be applied to products having concave portions formed on both sides surfaces thereof. Referring to FIG. 5, the embodiment will be described.

In the figures the same reference numerals will be used as those of the first preferred embodiment corresponding to the mutual parts, and won't be precisely described here.

This forging device have a cope 1 having a punch 10 and a drag 2 having a counter punch 11 and the upper punch 10 and the counter punch 11 are provided symmetrically. Surfaces for forming chamfers 6 are formed around at the bases of these punches 10, 11 corresponding to corner parts of the cut-finished surfaces and the adjacent surfaces as same as the first embodiment.

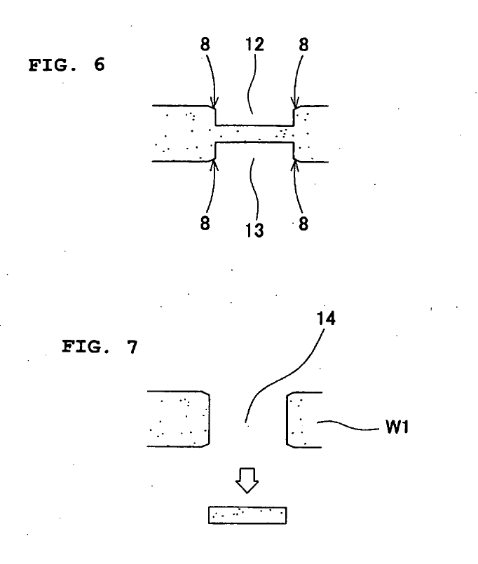

Referring to FIG. 6, when a work W is pressed by sending the cope 1 down, the work W is depressed in the cavity 2a and upper and lower concave portions 12, 13 having a chamfer part 8 formed at the corner part of mouth thereof are formed respectively on the surfaces depressed from both sides by the upper punch 10 and the counterpunch 11.

After removing the work W from the forging device, the both sides surfaces of the work W are finished by cutting.

As described in the first preferred embodiments, the cut-finished surface is cut so as to remain the chamfer part 8 at the corner part of the finished surface F and the concave portions 12,13. Therefore, it is possible to prevent occurring weld flash on an elongation of a cutting direction.

As shown FIG. 7, a part wedged between concave portions may be left or may be pierced so as to form a penetrating hole 14 by pierce process.

The penetrating hole may be formed at the step of the first molded article. In a case that the penetrating hole is formed by forging, a sloping surface having a desired angle may be formed under certain conditions and there is an advantage that the sloping surface of the draft angle can be used as a chamfer.

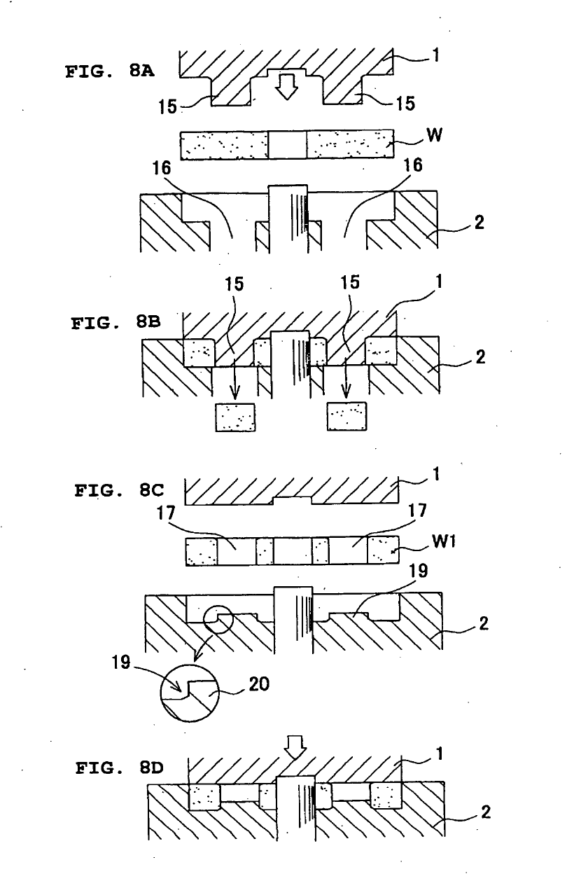

Referring to FIGS. 8A-8D, the first molded article having a penetrating hole will be described.

The forging device comprises a cope 1 provided with a projected penetrating punch 15 whose length is slightly longer than that of the depth of a cavity and a drag 2 provided with a penetrated down hole 16 whose cross section area is larger than that of the penetrated down punch 15, formed on a part corresponding to the penetrated down punch 15.

When a doughnut-type work W is molded to form a penetrated down hole 17 by such a forging device, a chamfer 8 is formed on the top surface of the work W and simultaneously a sloping surface 18 of the draft angle is formed at a mouth of a hole of a bottom surface as shown in FIG. 9.

The top surface of the work W is cut so as to remain a chamfer 8 formed at a corner part of a finished surface F and a penetrating hole 17 as same as the first or second embodiment of the present invention and the bottom surface is cut in the finishing so as to remain the sloping surface 18 and the sloping surface is used in place of the chamfer. And that ends to prevent occurring weld flash.

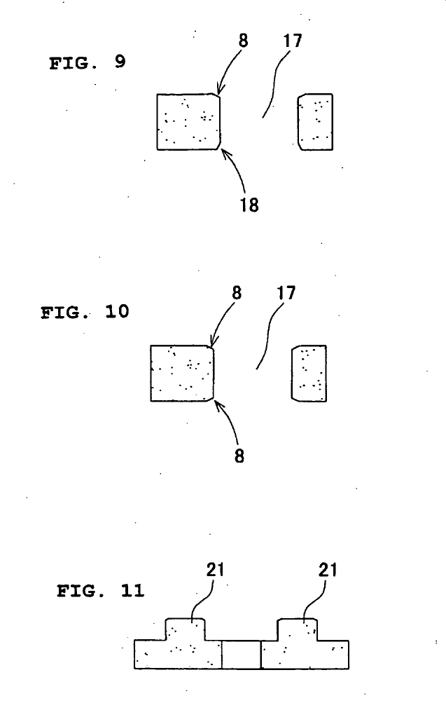

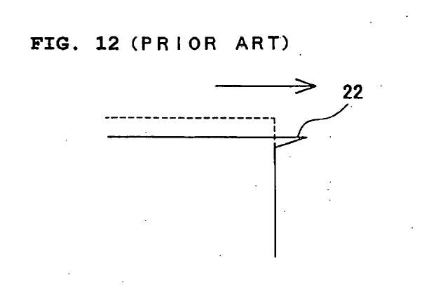

The sloping surface of the draft angle is not only used in place of the chamfer, but also as shown in FIG. 8C after molding a penetrating hole, the chamfer may be formed by the sloping surface with the forging device provided a projected down punch 20 having a part for forming 19 on the bottom of a cavity 2a, and then the cut-finished surface will be able to cut by cutting process as shown in FIG. 10.

In each embodiment, a tooth form is formed by cutting the first molded article having no tooth form. Although, the tooth form, a concave portion and a penetrating hole may be formed simultaneously.

Further, a chamfer part may be formed at not only corner part of mouth of concave portions but also every part on which weld flash is generated on elongation of cut-finished surface by cutting, in other words, every corner part of finished surface. Therefore, as a matter of course, this technique may be applied to all machine parts except a clutch gear provided with concave portions or the penetrating hole and may be applied favorably to a case that an edge surface of projective portion 21 is finished as shown in FIG. 11.

According to the embodiments, as described above, weld flash would not be occurred on the corner part. In the present embodiment the cut-finished surface is cut so as to remain a chamfer part which is beforehand formed on the corner part by forging process.

In the embodiment, a number of process is few owing to forming the chamfer, the concave portion or the hole simultaneously by one press molding step, but all steps other than chamfering may be carried out by cutting.

The preferred embodiments of the present invention, as herein disclosed are taken as some embodiments for explaining the present invention. It is to be understood that the present invention should not be restricted by these embodiments and any modifications and additions are possible so far as they are not beyond the technical idea or principle based on descriptions of the scope of the patent claims.

1. A chamfer processing method for forming a chamfer part on a product which has a cut surface and an adjacent surface having the different angle with that of said cut surface, wherein comprises:
chamfer process step for chamfer processing previously at a corner part between said cut surface and said adjacent surface in order to form said chamfer part, and
cutting step for cutting said cut surface in order to remain said chamfer part on said corner part between said cut surface and said adjacent surface.

2. A chamfer processing method according to claim 1, wherein said cut surface is a cut-finished surface finished by cutting, and said adjacent surface is intersected with said cut-finished surface.

3. A chamfer processing method according to claim 2, wherein said chamfer part is press molded.

4. A chamfer processing method for forming a chamfer part in a producing method for molding a product which has a cut-finished surface by cutting and an adjacent surface intersected with said cut-finished surface, wherein comprises
chamfer processing step for chamfer processing previously said chamfer part by press molding at a corner part between said cut-finished surface and said adjacent surface in order to form said chamfer part, and
cutting step for cut-finishing said cut-finished surface in order to remain said chamfer part on said corner part between said cut-finished surface and said adjacent surface.

5. A chamfer processing method for forming a chamfer part in a producing method for molding a product which has a cut-finished surface by cutting and penetrated hole or concave portion opening to said cut-finished surface, wherein comprises:
chamfer processing step for chamfer processing previously said chamfer part by press molding at a corner part between said cut-finished surface and said penetrated hole or concave portion, and
cutting step for cut-finishing said cut-finished surface in order to remain said chamfer part on said corner part between said cut-finished surface and said penetrated hole or concave portion.

6. A chamfer processing method according to claim 5, wherein said molded part and said chamfer part of said product are formed simultaneously by one press molding step.

7. A chamfer processing method for forming a chamfer part in a producing method for molding a product which has a cut-finished surface by cutting and penetrated hole opening to said cut-finished surface, wherein
said chamfer part having the draft angle is formed at a corner part between said cut-finished surface and said penetrated hole formed by punching of a punch, and
said cut-finished surface is cut-finished in order to remain said chamfer having the draft angle at said corner part between said cut-finished surface and said penetrated hole.

8. A chamfer processing method for forming a chamfer part in a producing method for molding a product which has a cut-finished surface by cutting and penetrated hole opening to said cut-finished surface, wherein
said chamfer part having the draft angle is formed at a corner part between said cut-finished surface and said penetrated hole formed by punching of a punch from the opposite side of said cut-finished surface to said cut-finished surface, and
said cut-finished surface is cut-finished in order to remain said chamfer having the draft angle at said corner part between said cut-finished surface and said penetrated hole.

9. A forging device for forming a product having a cut surface and adjacent surface having the different angle with that of said cut surface, wherein comprises:
a chamfer processing portion for chamfer processing provided at a part corresponding to a corner part between said cut surface and said adjacent surface.

10. A product having a chamfer part between a cut surface and an adjacent surface having the different angle with that of said cut surface, wherein
said chamfer part is press molded at a corner part between said cut surface and said adjacent surface.

11. A product having a chamfer part between a cut-finished surface and a penetrated hole or a concave portion opening to said cut surface, wherein
said chamfer part is press molded at a corner part between said cut surface and said adjacent surface.

12. A product having a chamfer part at a corner part between a cut-finished surface and a penetrated hole opening to said cut-finished surface, wherein
said chamfer part having the draft angle is formed at said corner part between said cut-finished surface and said penetrated hole by punching of a punch from the opposite side of said cut-finished surface to said cut-finished surface.

13. A product: having a chamfer part: between a cut surface and an adjacent surface having different angle with that of said cut surface according to claim 10, wherein
said cut surface is cut in order to remain said chamfer part on said corner part between said cut surface and said adjacent surface.

14. A product having a chamfer part between a cut surface and an adjacent surface having different angle with that of said cut surface according to claim 13, wherein
said cut surface is a cut-finished surface finished by cutting, and
said adjacent surface is intersected with said cut-finished surface.

15. A product having a chamfer part between a cut surface and an adjacent surface having different angle with that of said cut surface according to claim 14, wherein
said chamfer part is press molded.

16. A product having a chamfer part formed by molding a product which has a cut-finished surface by cutting and an adjacent surface intersected with said cut finished surface, wherein
said chamfer part is previously processed by press molding at a corner part between said cut-finished surface and said adjacent surface in order to form said chamfer part, and
said cut finished surface is cut-finished in order to remain said chamfer part on said corner part between said cut-finished surface and said adjacent surface.

17. A product having a chamfer part between a cut-finished surface and a penetrated hole or a concave portion opening to said cut surface, wherein
said cut surface is cut in order to remain said chamfer having the draft angle at said corner part between said cut-finished surface and said penetrated hole.

18. A product having a chamfer part between a cut-finished surface and penetrated hole or a concave portion opening to said cut surface according to claim 11, wherein
said cut surface is cut in order to remain said chamfer having the draft angle at said corner part between said cut-finished surface and said penetrated hole or concave portion.

19. A product having a chamfer part between a cut-finished surface and penetrated hole or a concave portion opening to said cut surface according to claim 18, wherein
said molded part and said chamfer part of said product formed simultaneously by one press molding.

20. A product having a chamfer part at a corner part between a cut-finished surface and a penetrated hole opening to said cut-finished surface according to claim 12, wherein
said cut-finished surface is cut-finished in order to remain said chamfer having the draft angle at said corner part between said cut-finished surface and said penetrated hole.

21. A product having a chamfer part formed by molding a product which has a cut-finished surface by cutting and penetrated hole opening to said cut-finished surface, wherein
said chamfer part having the draft angle is formed at a corner part between said cut-finished surface and said penetrated hole formed by punching of a punch from the opposite side of said cut-finished surface to said cut-finished surface.

22. A product having a chamfer part formed by molding a product which has a cut-finished surface by cutting and penetrated hole opening to said cut-finished surface according to claim 21, wherein
said cut-finished is cut-finished in order to remain said chamfer having the draft angle at said corner part between said cut-finished surface and said penetrated hole.
